(19) United States
(12) Patent Application Publication
(10) Pub. No.: US 2017/0011422 A1
(43) Pub. Date: Jan. 12, 2017

(54) DATA PROCESSING DEVICE AND DATA PROCESSING METHOD

(71) Applicant: LINE CORPORATION, Tokyo (JP)

(72) Inventors: Heechan YANG, Tokyo (JP); Kenichi SUGIMOTO, Tokyo (JP)

(21) Appl. No.: 15/085,546

(22) Filed: Mar. 30, 2016

(30) Foreign Application Priority Data
Jul. 6, 2015 (JP) 2015-134970

(51) Int. Cl. G06Q 30/02; H04W 4/00; H04B 5/00; H04L 29/08

(52) U.S. Cl. CPC G06Q 30/0256; G06Q 30/0269; H04L 67/22; H04L 67/02; H04W 4/008; H04B 5/0031; H04L 67/1097

(57) ABSTRACT

A data processing device is provided including an identification data acquisition part which acquires identification data unique to a user input from a user terminal, an activity history data acquisition part which acquires activity data related to communication of a user terminal, an activity history data storage part which correlates activity data and identification data and stores this as activity history data, and an activity history data output part which outputs the stored activity history data.

### CROSS REFERENCE TO RELATED APPLICATIONS

This application is based upon and claims the benefit of priority from the prior Japanese Patent Application No. 2015-134970, filed on Jul. 6, 2015, the entire contents of which are incorporated herein by reference.

### FIELD

The present invention is related to a data processing device and a data processing method. Specifically, the present invention is related to a tracking server, a tracking method, an advert provision server and an advert provision method, and is also related to a tracking server, a tracking method, an advert provision server and an advert provision method which use identification data (user ID for example) unique to a user which is used in a social network service (referred to herein as [SNS]).

### BACKGROUND

User tracking has been mainly developed as an advertising technology on the Web. For example, an advertising technique is known whereby a banner of a product with a high level of correlation or high level of interest has been specified based on the activity history of a shopping site visited previously by a user is displayed on the Web page being browsed by the user in order to induce the user to revisit the shopping site.

In this tracking technique, a method is adopted whereby the provider of a Web site correlates data (cookie for example) with a user ID and temporarily writes and stores the data (cookie for example) in the computer of the visitor through the Web browser.

It is possible to store data specified on the Web site side in advance in the cookie and it is possible to record in advance the identity or data related to attributes of a user or the last time the site was visited in the cookie.

The problem was that tracking can only be performed based on a cookie provided to a user. In addition, there was a problem of interference from a cookie tag. Furthermore, there was a problem whereby tracking of the activity of a user can not be performed centrally when an individual uses a plurality of devices or browsers.

For example, there is a method in which a received banner ID is used as session data and a session correlated and stored with a generated unique key is established as a method for tracking a session and transactions in real time without the use of a cookie (Japanese Laid Open Patent No. 2002-288070). However, even when this method is used, the problem whereby tracking of the activity of a user can not be performed centrally when an individual uses a plurality of devices or browsers still remains.

### SUMMARY

Conventionally, the activity of a user is tracked by providing a cookie to a user using a HTML tag or the like in each web page. However, there was a problem whereby tracking can only be performed based on the cookie provided to a user. In addition, there is also a problem of tag interference. Furthermore, there is also a problem whereby tracking of the activity of a user can not be performed centrally when a user uses a plurality of devices or browsers.

In an attempt to solve these problems, one embodiment of the present invention provides a data processing device and method which tracks the activity of a user without being based on a cookie. In addition, a data processing device and method are provided which appropriately provide an advert to a user without being based on a cookie.

A data processing device related to one embodiment of the present invention includes an activity history data storage part storing activity history data formed by correlating identification data unique to a user and activity data related to communication of a user terminal, and an activity history data output part outputting the stored activity history data.

In one embodiment of the present invention, the data processing device may further include an identification data acquisition part and an activity history data acquisition part, the identification data acquisition part mat acquire the identification data, the activity history data acquisition part may acquire the activity data, and the activity history data storage part may further correlate the activity data with the identification data.

In one embodiment of the present invention, the identification data may be data unique to a user provided by a second data processing device distinct from the data processing device.

In one embodiment of the present invention, the identification data may further include user terminal specific data for specifying a terminal of a user.

In one embodiment of the present invention, the activity data acquisition part may acquire data of a web page accessed by a user or acquire data related to activities of a user stored in a service provider's server.

In one embodiment of the present invention, the second data processing device may provide a user with the identification data and provides a SNS.

In one embodiment of the present invention, the activity data may further include data of activity using near field wireless communication.

In one embodiment of the present invention, a prediction part configured to estimate attributes of a user and an attribute data output part configured to output data related to the attributes may be further included by using at least the activity history data.

In one embodiment of the present invention, a history data search part may be included configured to search for at least one of a specific web page specified by a third party and history data related to the specified web page.

In one embodiment of the present invention, the attribute may include at least one of demographic data of a user and interested fields.

In one embodiment of the present invention, an advert selection part configured to select an advert to be displayed to a user based on the activity history data, and an advert provision part configured to provide data of an advert selected by the advert selection part to the user terminal may be further included.

In one embodiment of the present invention, he advert selection part may select an advert reflecting the attribute.

A data processing method related to one embodiment of the present invention includes storing activity history data formed by correlating identification data unique to a user and activity data related to communication of a user terminal, and outputting the stored activity history data.

In one embodiment of the present invention, the identification data may further include user terminal specific data for specifying a terminal of a user.

In one embodiment of the present invention, acquiring the activity data may be performed by acquiring data of a web page accessed by a user or acquiring data related to communication activities of a user stored in a service provider's server.

In one embodiment of the present invention, the activity data may include data of activities using near field wireless communication.

In one embodiment of the present invention, attributes of a user may be estimated and data related to the attributes may be output by using at least the activity history data.

In one embodiment of the present invention, at least one of a specific web page specified by a third party and history data related to the specified web page may be searched.

In one embodiment of the present invention, the attribute may include at least one of demographic data of a user and interested fields.

In one embodiment of the present invention, an advert to be displayed to a user may be selected based on the activity history data, and data of an advert selected by an advert selection part may be provided to the user terminal.

In one embodiment of the present invention, an advert may be selected reflecting the attribute.

According to one embodiment of the invention, an advertiser can perform tracking without being based on a cookie provided to a user. In addition, it is possible to perform tracking without interference of a tag. Furthermore, it is possible to centrally perform tracking the activities of a user even when an individual uses a plurality of devices or browsers.

### BRIEF DESCRIPTION OF THE DRAWINGS

FIG. 1 is a diagram showing the details of a server related to one embodiment of the present invention;

FIG. 2 is a diagram showing a method of acquiring identification data related to one embodiment of the present invention;

FIG. 3 is a diagram showing the details of a server related to one embodiment of the present invention;

FIG. 4 is a diagram showing a method of estimating an attribute by a prediction part related to one embodiment of the present invention;

FIG. 5 is a diagram showing the details of a server related to one embodiment of the present invention;

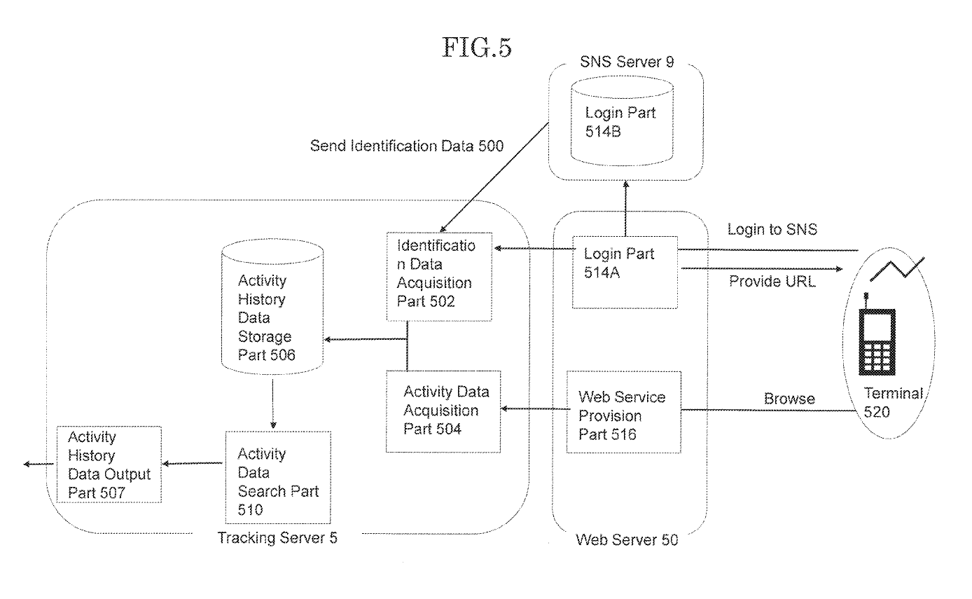

FIG. 6 is a diagram showing the details of a server related to one embodiment of the present invention;

FIG. 7 is a diagram showing the details of a server related to one embodiment of the present invention; and

FIG. 8 is a diagram showing a method of estimating an attribute by a prediction part related to one embodiment of the present invention.

### DESCRIPTION OF EMBODIMENTS

The embodiments of the present invention are explained below while referring to the drawings. However, the present invention can be performed using many different forms and should not be interpreted as being limited to the content described in the embodiments exemplified herein. For example, although many examples of advertisement provision are described in the present specification, tracking in the present invention is not limited to advertisement provision and may be applied to various fields such as market research, statistical analysis, education or games and the like. In the present specification and each drawing, the same reference symbols are attached to the same elements previously mentioned in relation to a previously presented drawing and therefore a detailed explanation may be omitted where appropriate. In addition, although an explanation is provided below according to the flow of processes by combining an advertisement provision server, advertisement provision method and tracking method in order to provide a clearer explanation, the present invention also encompasses actions for performing these separately. For example, realizing the present invention by implementing each component separately on two or more servers and separating roles on two or more servers is also included in the content of the present invention.

### First Embodiment

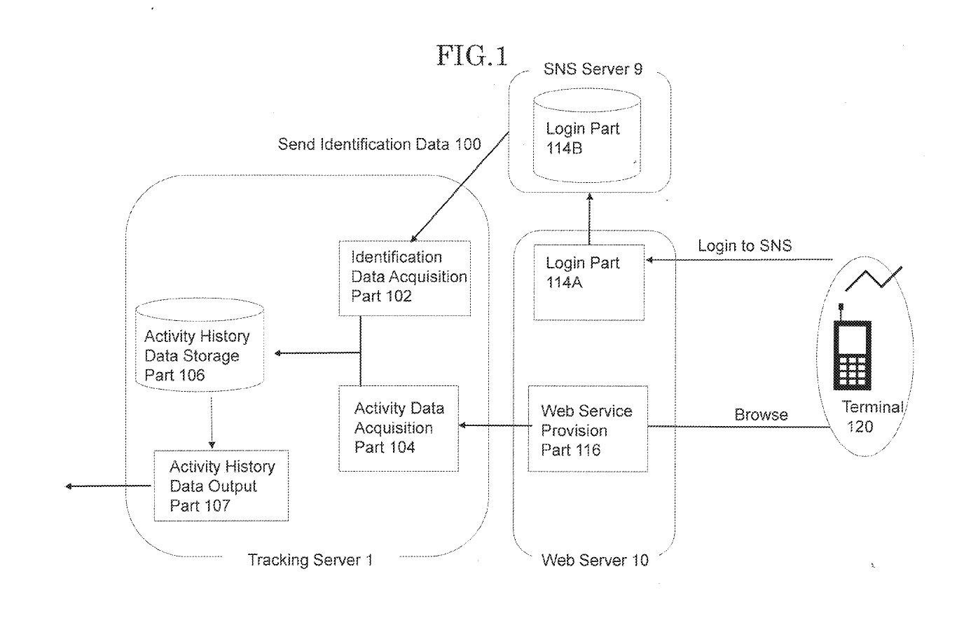

As is shown in FIG. 1, when a user browses the Web, a tracking server 1 acquires identification data 100 to be used in a SNS (social network service) and the like. For example, the identification data may be a character string correlated with an account which is provided by the SNS. The identification data may be an identifier sufficient for identifying an individual by making the identifier unique to the user. Although a mail address or user ID is not excluded from the identification data, the identification data is basically different to a mail address of user ID used in a SNS and is data that has not been seen by a user and is set on the SNS server side.

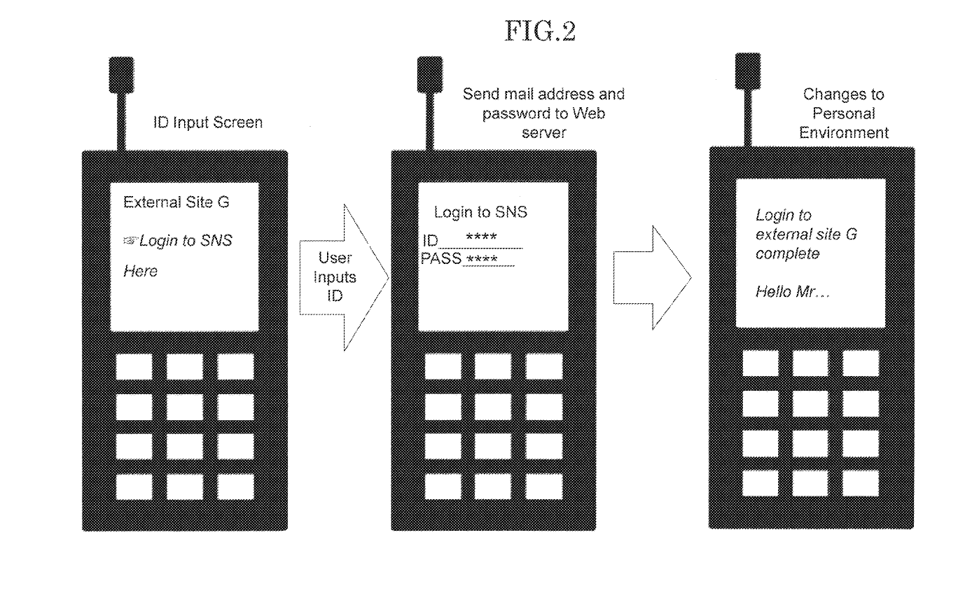

A tracking server may acquire identification data via a login server or external Web provider server (the login server and external Web provider server are collectively referred to herein simply as a Web server) (FIG. 1). This is shown as Web server 10 in FIG. 1. In this case, a user selects login to SNS on a screen in a service provided by Web server 10 (for example, a server which provides a different site to a SNS site such as a shopping site and the like) and inputs a user ID and password used on the SNS into a user terminal (FIG. 2). Next, the user ID and password are sent to a SNS server via a network from the user terminal and the SNS server is in a state for receiving an authentication request. Next, the SNS server sends identification data to the tracking server. Furthermore, a URL accessed by a user may also be sent and identification data and a URL may be correlated and sent to the tracking server or just the identification data may be sent at this time. In this case, a URL and the like accessed by a user is sent to the tracking server from the Web server 10.

In the present invention, it is important that the identification data is data unique to a user (for example, just one character string data provided with respect to one SNS ID with respect to one telephone number). For example, the present invention is not realized by data which becomes effective just in a single session such as a one-time ID. Identification data such as a SNS expressed in the present specification does not mean being limited to identification data used in a SNS but identification data unique to an individual allocated in a SNS or the like and is used as an example since it is not a one-time ID.

In addition, when acquiring the identification data 100, the IP address of the terminal which sent the identification data 100, data related to the internet connection environment, and location data via GPS may also be acquired and stored. In this way, it is possible to perform tracking of each terminal when tracking an individual. Recently, since an individual often accesses different sites using different terminals and uses different terminals for different situations, it is possible to more accurately track the activity of an individual in order to be able to understand variation in the activity patterns of each terminal. In addition, it is possible to provide more appropriate adverts to a user terminal by more accurately tracking the activity of an individual.

Furthermore, although an ID unique to a terminal (MAC address, a UDID of an OS) may also be acquired, it is also possible not to acquire an ID unique to a terminal due to security since an ID unique to a terminal can not be expressly changed by a user. In addition, the present invention can also perform accurate tracking without using an ID unique to these terminals and it is a feature of the present invention that it is possible to provide an advert appropriately.

In addition, since the present embodiment uses identification data held by a user in advance, it is not a concept whereby a terminal is identified by combining parameters that can be acquired during communication unlike Device Fingerprinting. Although identification accuracy is slightly improved by increasing the number of parameters even if a terminal is identified by combining parameters that can be acquired during communication, the ability to perform identification can not be consistently maintained since the parameters of the terminal which is used are changed during an upgrade in the version of an OS for example.

In the present embodiment, it is sometimes possible to determine the area of the nearest connection point by acquiring not only identification data 100 but also an IP address, and it is also possible to understand location data of an individual. If this is combined with tracking data, it is also possible to understand the activity patterns of a user for each area. In addition, it is possible to provide an advert for each area and more effectively provide an advert to a user terminal.

The tracking server 1 adds an item such as login to an SNS over the internet for example in order to acquire the identification data 100 and a username and password used by a user on the SNS are input here (FIG. 2). A technique is possible whereby authentication is performed by a SNS service server and the like in response to this and if authenticated, the identification data 100 and data of a Web page (URL etc) are sent to the tracking server by the SNS service server. In this way, the identification data 100 is not always limited to an ID input by a user.

In addition, since it is also possible to store the identification data 100 in a storage memory and the like of a terminal managed by a Web browser, there is no inconvenience to a user after the second login. Therefore, the expression “identification data unique to a user input from a terminal” in the present application does not mean that a user must input identification data each and every time.

A method whereby the identification data 100 while a user is already logged in and a URL of a page to be accessed when using a Web browsing function on a SNS application is sent to the SNS application may be used as a method of acquiring the identification data 100.

Here, login to a SNS mentioned in FIG. 1 refers to a login by a login server to an external site (for example, a Web data provision service managed by a party other than a SNS operator etc). Here, login to a SNS refers to a series of services which can permit access to one's own data by inputting specific identification data of an individual of a SNS (for example, mail address and password), and receive a service on the internet in a personalized environment even on an external site.

In order to implement a SNS login, an external site (also referred to as a Web server in the present application) which uses a login system of the SNS may be considered as one application in the SNS. In addition, a known method such as Azure Active Directory Access Control Service (registered trademark) may also be used.

Although a mobile phone is displayed as a terminal 120 used by a user in the drawings, there is no particular limitation to the terminal and any electronic device including a communication function can be used. For example, a mobile phone, smart phone, tablet type terminal, FDA (Personal Digital Assistants), personal computer, wearable terminal (wrist watch type wearable terminal, glasses type wearable terminal etc) and television are included.

Data related to the activity of a user is acquired and stored by an activity data acquisition part 104. As a method for implementing this, history may be acquired by creating a session database and storing in an ID acquisition part. A method is also possible in which identification of a user (ID, IP address, one-time ID) is acquired from a HTFP header etc sent from a user terminal and stored. It is also possible to use other known methods (TCP/IP technology etc).

Furthermore, activity data may also be, but not limited to, for example, stored data using near field wireless communication, data and the content of an accessed web page, data related to communication activity of a user stored in an external server (service provider server), service usage data by a user stored in an external server (service provider server), product purchase history or purchased product data by a user collected and already stored in an external server (service provider server), installed application data, and data stored due to use of a cooperating application.

A terminal device of a user may be connected with a SNS server providing a SNS separate from the tracking server 1. In this case, it is possible to perform tracking with a higher degree of accuracy by a combination with tracking performed by a SNS server. The concept of the present invention is to make tracking with a high degree of accuracy possible by a method described herein and not an essential structure in which a terminal is connected to a SNS server via the internet.

The activity history of a user is acquired by the history data acquisition part 104 of the tracking server and stored by an activity history data storage part 106. Data related to the activity history of a user to be acquired by the history data acquisition part 104 includes the browsing time of a user, length of browsing time, details of the browsed content and categories of the browsed content. The saved history data can be output by a history data output part 107 and read.

The activity history data storage part 106 links the activity data of a user with an ID. In this way, the activity data of a user is linked with a specific ID and it is possible to track the activity of an individual.

According to one embodiment of the present invention, it is possible to more accurately track an individual by using identification data unique to an individual user.

### Second Embodiment

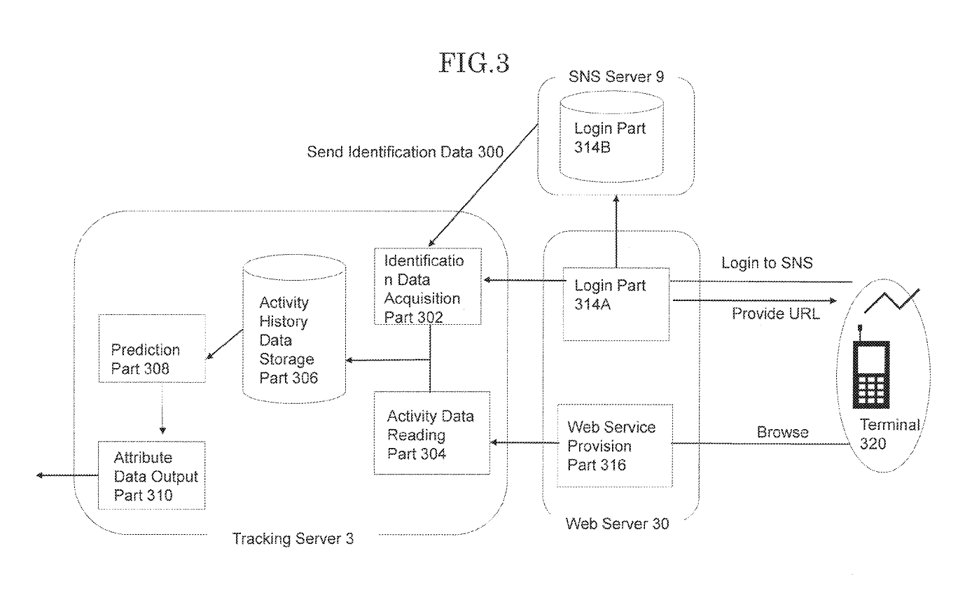

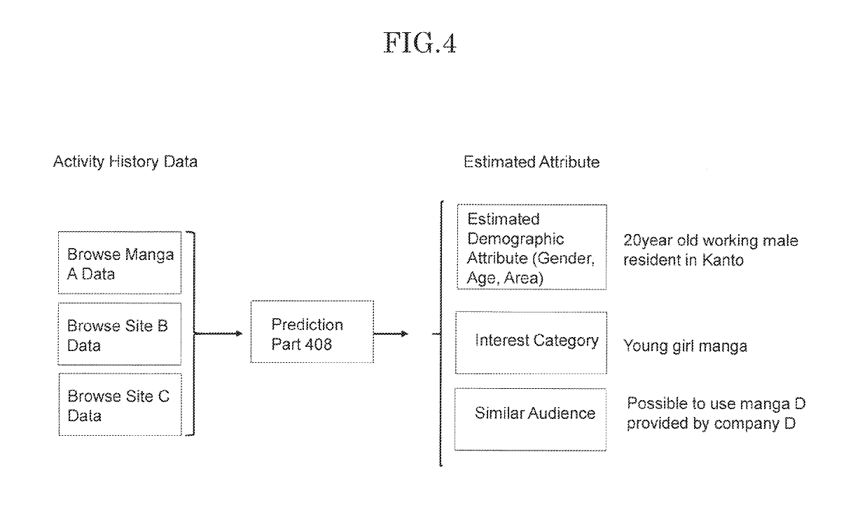

In one embodiment of the present invention, a prediction part may be included in addition to an identification data acquisition part, activity data acquisition part and history data storage part described previously in a tracking server and the prediction part may estimate an attribute of a user using at least the activity history data (FIG. 3, FIG. 4).

For example, not only demographic attributes such as gender, address, age group, social status, income, presence of a spouse or dependent but also interests of a user, type of services predicted to be used in the future and type of applications predicted to be billed are included as attributes of a user estimated by the prediction part.

The prediction part may simply change the weighting with respect to elements within the activity history data without using the activity history data and may also estimate attributes based on data other than the activity history data.

In FIG. 4, the prediction part estimates attributes of a user browsing manga A, site B and site C. The prediction part estimates that the estimated demographic attributes of a user are a working male in his 20's resident in Kanto, has an interest in young girl's manga, and that it is possible to next read manga D provided by company D.

### Third Embodiment

According to one embodiment of the present invention, a tracking server may further include a history data search part. Furthermore, the identification data acquisition part, activity data acquisition part and activity history data storage part are as explained previously.

Here, the history data search part can search for and process a specific address input by a third party apart from a user (for example, a party wishing to provide tracking data) or an address of a specific site and similar addresses, from an activity history data storage part 506.

For example, a party wishing to provide tracking data sends the URL of a site E to the history data search part. Next, the history data search part searches for data related to a user who has accessed site E and the history data search part provides data of a user who has accessed site E to the party wishing to provide tracking data.

### Fourth Embodiment

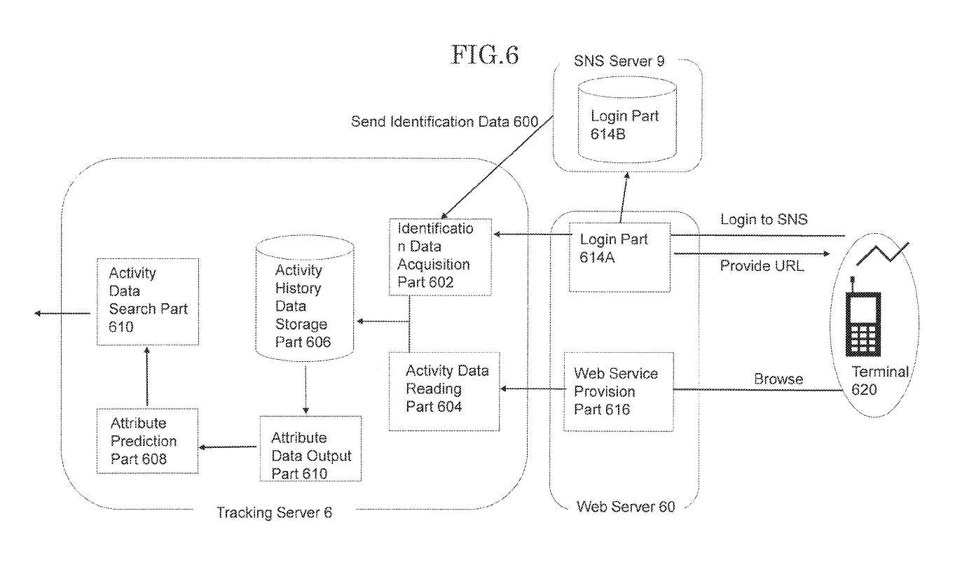

In addition, as is shown in FIG. 6, a tracking server may also include a prediction part and a history data search part in addition to the identification data acquisition part, activity data acquisition part and activity history data storage part. In the case where the tracking server includes a prediction part and history data search part, the history data search part can also provide attributes of a user who has accessed site E to a party wishing to provide tracking data.

### Fifth Embodiment

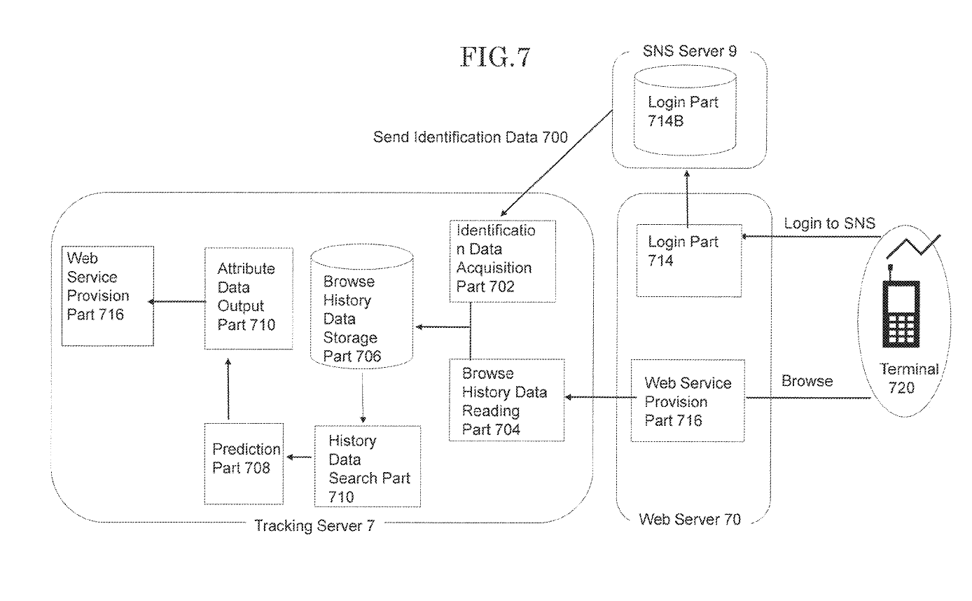

As is shown in FIG. 7, an advert provision server may also include an identification data acquisition part, activity data acquisition part, activity history data storage part, prediction part 708 and an advert provision part 712. A history data search part may be further included in the case where the advert provision part 712 is included. The identification data acquisition part, activity data acquisition part, activity history data storage part, prediction part and history data search part implemented in an advert provision server can be selected from any of the first to fourth embodiments already explained.

The advert provision part 712 selects an advert to display to a user based on an attribute estimated by the prediction part and provides data of the advert selected by an advert provision part 712 to the user terminal 722.

Here, a terminal 720 may be the same as or a different terminal to the terminal 722. In the case where the terminal 720 is the same as the terminal 722, an attribute is estimated by the prediction part based on the activity history data obtained by tracking of the terminal 720, and an advert to be displayed to a user is selected by an advert provision part 712 based on at least this attribute and displayed in the terminal 720.

Alternatively, in the case where the terminal 720 and terminal 722 are different, in the present invention it is possible to estimate an attribute of a user based not on data unique to a terminal but on identification data unique to a user, and display an advert in the terminal 722 according to the attribute.

That is, if identification data is sent from the terminal 722, the identification data acquisition part can judge whether the terminal 720 and the terminal 720 are terminals of the same user, the tracking server 7 can estimate an attribute based on the activity history data obtained from tracking of the terminal 720, and display an advert selected by an advert provision part in the terminal 722 which is a terminal of the same user.

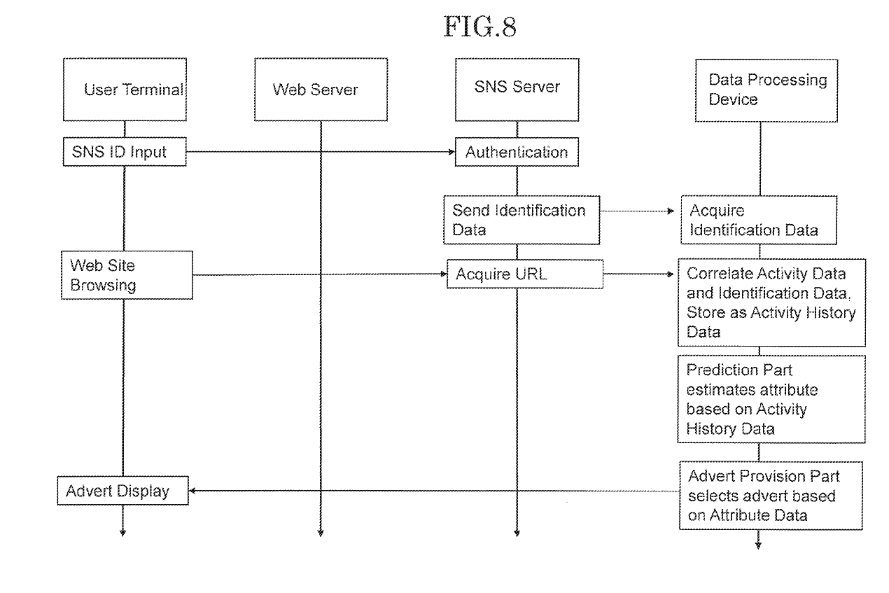

A flow of data in one embodiment of the present invention is shown in FIG. 8. Furthermore, each structure is a specific structure. The changes as described in the embodiments above may also be added.

A SNS ID is sent to a SNS server from a user terminal. The SNS server authenticates the ID and sends identification data to a data processing device. In this way the data processing device acquires identification data. Activity data (URL) related to Web site browsing etc is sent to the SNS server. The SNS server sends the URL to the data processing device and the data processing device stores the URL. At this time, the activity data and identification data may be correlated in the SNS server or a Web server or correlated in the data processing device as explained above. A prediction part of the data processing device estimates an attribute based on the correlated activity history data. An advert provision part selects an advert based on the estimated attribute and the advert is displayed in a terminal.

As explained above, according to one embodiment of the present invention, it is possible to more accurately perform tracking without being based on a cookie provided to a user. In addition, there is no interference by a tag. Furthermore, it is possible to centrally perform tracking of the activity of a user even if an individual uses a plurality of devices or browsers, In addition, it is possible to provide an appropriate advert to a user.

1. A data processing device comprising:
an activity history data storage part storing activity history data formed by correlating identification data unique to a user and activity data related to communication of a user terminal; and
an activity history data output part outputting the stored activity history data.

2. The data processing device according to claim 1, wherein the data processing device further includes an identification data acquisition part and an activity history data acquisition part, the identification data acquisition part acquires the identification data, the activity history data acquisition part acquires the activity data, and the activity history data storage part further correlates the activity data with the identification data.

3. The data processing device according to claim 1, wherein the identification data is data unique to a user provided by a second data processing device distinct from the data processing device.

4. The data processing device according to claim 1, wherein the identification data further includes user terminal specific data for specifying a terminal of a user.

5. The data processing device according to claim 1, wherein the activity data acquisition part acquires data of a web page accessed by a user or acquires data related to activities of a user stored in a service provider's server.

6. The data processing device according to claim 3, wherein the second data processing device provides a user with the identification data and provides a SNS.

7. The data processing device according to claim 1, wherein the activity data further includes data of activity using near field wireless communication.

8. The data processing device according to claim 1, wherein a prediction part configured to estimate attributes of a user and an attribute data output part configured to output data related to the attributes are further included by using at least the activity history data.

9. The data processing device according to claim 1, wherein a history data search part is included configured to search for at least one of a specific web page specified by a third party and history data related to the specified web page.

10. The data processing device according to claim 8, wherein the attribute includes at least one of demographic data of a user and interested fields.

11. The data processing device according to claim 1 wherein an advert selection part configured to select an advert to be displayed to a user based on the activity history data, and an advert provision part configured to provide data of an advert selected by the advert selection part to the user terminal are further included.

12. The data processing device according to claim 11, wherein the advert selection part selects an advert reflecting the attribute.

13. A data processing method comprising:
storing activity history data formed by correlating identification data unique to a user and activity data related to communication of a user terminal; and
outputting the stored activity history data.

14. The data processing method according to claim 13, wherein the identification data further includes user terminal specific data for specifying a terminal of a user.

15. The data processing method according to claim 13, wherein acquiring the activity data is performed by acquiring data of a web page accessed by a user or acquiring data related to communication activities of a user stored in a service provider's server.

16. The data processing method according to claim 13, wherein the activity data includes data of activities using near field wireless communication.

17. The data processing method according to claim 13, wherein attributes of a user are estimated and data related to the attributes are output by using at least the activity history data.

18. The data processing method according to claim 13, wherein at least one of a specific web page specified by a third party and history data related to the specified web page are searched.

19. The data processing method according to claim 17, wherein the attribute includes at least one of demographic data of a user and interested fields.

20. The data processing method according to claim 13, wherein an advert to be displayed to a user is selected based on the activity history data, and data of an advert selected by an advert provision part is provided to the user terminal.

21. The data processing method according to claim 13, wherein an advert is selected reflecting the attribute.
